(19) United States
(12) Patent Application Publication
(10) Pub. No.: US 2016/0280588 A1
(43) Pub. Date: Sep. 29, 2016

(54) Inkjet Compositions For Forming Functional Glaze Coatings

(71) Applicant: Ferro Corporation, Mayfield Heights, OH (US)

(72) Inventors: Ana-Belén Gil-Torrente, Vila-Real (Castellon) (ES); Eugenio Silvestre-Lasa, Almazora (Castellon) (ES); Francisco-Javier Guaita-Delgado, Castellon (ES); Javier Gimeno-Navarro, Nules (Castellon) (ES); Jose Manrique-Navarro, Villarreal (Castellon) (ES); Juan Uso-Villanueva, Vall de Uxo (Castellon) (ES); Juan-Carlos Gallart-Pedro, Valencia (ES); Manuela Sales-Segarra, Rafelbunyol (Valencia) (ES)

(21) Appl. No.: 15/062,363

(22) Filed: Mar. 7, 2016

Related U.S. Application Data
(60) Provisional application No. 62/137,278, filed on Mar. 24, 2015.

(51) Int. Cl. C03C 8/16; B41J 11/00

(52) U.S. Cl. CPC C03C 8/16; B41J 11/002

(57) ABSTRACT

Inkjet compositions that can be applied to glass and/or ceramic substrates to impart contrast gloss (luster). The inkjet compositions include solvents, additives for dispersion, and inorganic substances, but preferably do not include any color-producing ceramic pigments. The inorganic substances contained in the inkjet compositions are responsible for the effects on the surface of the substrate.

### BACKGROUND OF INVENTION

1. Field of Invention

The present invention provides inkjet compositions that can be used to modify the physical properties of the surface of glass and ceramic substrates and thus provide a functional coating or glaze after firing.

2. Description of Related Art

It is conventional to apply colorants to ceramic substrates for decoration, and to apply glazes to obtain surface appearance effects. In recent years, much effort has been expended to obtain colorants that can be applied using inkjet application equipment. While these color-producing inks are suitable for their intended purpose, it would be advantageous if there were inkjet compositions that could be applied using conventional inkjet equipment to modify the appearance of the ceramic tile, while not interfering with the color development.

In particular, luster pigments containing tungsten oxides are known, providing an adequate luster effect.

### BRIEF SUMMARY OF THE INVENTION

The present invention provides inkjet compositions that can be used to modify the physical properties of the surface of glass and ceramic substrates and thus provide a functional coating or glaze after firing. The physical properties of the ceramic article that can be changed or modified with the inkjet compositions of the present invention can affect various attributes of the ceramic article after firing, including: gloss, matt, contrast gloss (luster), specular reflection (metallic appearance), relief and slipperiness.

In particular, a luster effect can be achieved through inkjet printing at particle sizes (less than ca. 20 microns) that cannot be applied by traditional screen-printing methods. Further, improved luster effect can be obtained with a micron scale pigment including ceria and zirconia, with a luster effect equal to or superior to that obtainable with tungsten containing inks. Pigments wholly lacking tungsten are envisioned as embodiments herein. However, combinations of tungsten frits and ceria-zirconia frits also may be used.

The inkjet compositions according to the invention include solvents, additives for dispersion, and inorganic substances. The inorganic substances contained in the inkjet compositions are the responsible for the above mentioned effects on the surface of the ceramic article. Depending on the type of effect desired, the inorganic substance may be a specific frit, a crystalline oxide, or a combination of flits and crystalline oxides.

The inkjet compositions of the present invention may be used in conjunction with a variety of substrates including, for example: ceramic tiles (e.g., floor tile, wall tile etc.); dinnerware; brick tiles; glass; enameled steel; enameled cast iron; and enameled aluminum.

The foregoing and other features of the invention are hereinafter more fully described and particularly pointed out in the claims, the following description setting forth in detail certain illustrative embodiments of the invention, these being indicative, however, of but a few of the various ways in which the principles of the present invention may be employed.

### BRIEF DESCRIPTION OF THE DRAWINGS

FIG. 1 is a graph showing the relation between gloss and ink layer thickness.

### DETAILED DESCRIPTION OF THE INVENTION

Inkjet compositions according to the invention can be applied using inkjet decoration machines commonly used glazing lines of the above mentioned substrates. Also, inkjet plotter machines are commercially available, which permit the inkjet compositions to be used in a discontinuous way.

Inkjet machines may be used in simple-pass or multi-pass operating mode. In the simple-pass mode, the inkjet print head makes only one-pass over the surface of the substrate. In the multi-pass mode, the inkjet print head makes more than one-pass over the surface of the substrate. In some cases, several passes are needed on order to achieve the desired properties.

Many known types of inkjet print head technologies are suitable for use with inkjet compositions according to the present invention. Drop-on-demand technology is the most commonly employed technology in the ceramic industry.

Conventional inkjet compositions currently used on ceramic substrates, which are sometimes referred to in the art as “inks”, are utilized to provide coloration to the ceramic substrate when fired. For this purpose, conventional inkjet inks include solvents, dispersants and color-producing substances, which are typically ceramic pigments. The current ceramic pigments used in inkjet inks include zircon praseodymium yellow zircon, zinc iron chromite brown, cobalt aluminate blue, chrome tin pink sphene, iron cobalt chromite black spinel, etc.

In contrast with the above mentioned inkjet inks, the inkjet compositions according to the present invention preferably do not contain any color-producing ceramic pigments. Instead, they contain inorganic substances that, although milled below 10 micron size so as to be capable of being ink-jet printable and being applied as very low deposits, are applied to modify targeted physical properties of the ceramic surface on which they are applied. Modification of the physical properties of the ceramic substrate can affect various attributes of the ceramic article after firing, including: gloss, matt, contrast gloss (luster), specular reflection (metallic appearance), relief and slipperiness.

The use of inkjet technology provides the advantage of being able to apply the inkjet compositions in a determined place with high accuracy. So, the change of physical properties of the surface of the tile may follow an accurate pattern, opening new possibilities for tile decoration. It is seen as an advantage to combine the application of inkjet compositions according to the invention with the conventional pigmented inkjet inks. In this way, the ceramic article may be fully decorated using inkjet technology.

One object of the present invention is to develop a set of inkjet compositions having a completely distinct nature compared to current pigmented inkjet inks. Inkjet compositions according to the invention are capable of being applied using conventional inkjet printing equipment without clogging the spray nozzles. Thus, the preferable have appropriate physical properties, such as a viscosity within the range of from about 5 to about 50 mPa·s, a surface tension of from about 20 to about 40 mN/m, and a density of from about 0.8 to about 1.5 g/mL. Advantageously, the inkjet compositions according to the invention preferably exhibit little or no volatility, and are stable with the materials used to make inkjet printing systems (e.g., print heads, nozzles, delivery lines etc.).

In addition, it is advantageous for the inkjet compositions according to the invention to work with the requirements of ceramic systems. For example, they must be capable of developing the desired surface affect (i.e., the desired physical surface change) after firing. The must be capable of interacting with the glazed surface to become part of it. They must contain sufficient solids to allow reasonable productivity. And, they must allow for enough resolution despite the large amount to be deposited.

The quantity of the inkjet compositions according to the invention deposited on the surface of the ceramic substrate will depend on the type of effect desired. The inkjet compositions according to the invention can be applied over a wide range of application rates, from about 5 up to about 500 g/m², depending upon the desired affect. Typical application rates are used in the Examples below.

Several affects can be obtained using the disclosed inkjet compositions. The affects are provided mainly by the presence of a particular solid in the inkjet composition. The inkjet composition contains a solvent or diluent, a dispersant and the solid that creates the effect.

According to the present invention, the solid is dispersed in a solvent or diluent wherein the diluent is a single phase liquid comprising several solvents. This diluent can comprise aliphatic and/or aromatic hydrocarbon components as well as glycols, glycolethers, ethers, esters, alcohols, amides and/or water. In general, the diluent should have a boiling point of at least 100° C., and preferably at least 200° C. The diluent, as only one component or a combination of several ones, greatly determines the surface tension of the final ink, and thus it should have a surface tension within the print head requirements.

It is often necessary to include a dispersant to effectively disperse the solid particles into the diluent and stabilize the dispersion. The dispersant must be capable of helping the process of grinding and stabilizing a dispersion of the solid in the required concentration into the chosen diluent at least under the operating conditions of the printing. Polymeric dispersants are preferred because of their efficiency. Examples of suitable dispersant are polyester amine dispersants (e.g. those sold by Lubrizol under the trade name of SOLSPERSE). Examples of other dispersants that may be used are those marketed under the names EFKA and DISPERBYK. Mixtures of dispersants may be used if desired.

For a given combination of diluent, dispersant and solid, the appropriate amount of dispersant may readily be determined by experiment. The ideal amount of dispersant is typically that which gives the minimum viscosity of the dispersion. The suitable amount of dispersant(s) varies depending on the specific surface area and the nature of the solid and will be found to lie in a very broad range, e.g. from about 5 to about 100% by weight of solid; a larger amount of dispersant may be possible as well.

The viscosity is determined largely by the viscosity of the diluent and the nature and concentration of the dispersant and solid. Generally, the typical viscosity range is from about 5 to about 50 mPa s, measured at the temperature of jetting.

The dispersant is dissolved into the diluent and then the solid is added with stirring. After good dispersion is obtained, this slurry is milled using a conventional horizontal bead mill until the appropriate particle size distribution is obtained. The product is filtered to ensure that there is no coarse material or large agglomerates in the final suspension or inkjet composition.

The following examples are intended only to illustrate the invention and should not be construed as imposing limitations upon the claims.

### EXAMPLE 1

An inkjet composition according to the invention has been developed to provide a luster effect when fired on the ceramic tile. The solid component is a recently developed frit, which develops a luster effect (hereinafter sometimes referred to as a “luster frit”). The composition of the luster frit is shown in Table 1 below (weight percent), in broader and more preferred embodiments:

TABLE 1

| | | |
|---|---|---|
| SiO2 | 45-65% | 50-60% |
| Al₂O₃ | 8-20% | 9-18% |
| CaO | 5-15% | 7-14% |
| MgO | 0.1-3% | 0.1-2% |
| Na₂O | 0.1-3% | 0.1-2% |
| K₂O | 0.1-3% | 0.1-2% |
| ZnO | 5-15% | 7-14% |
| ZrO₂ | 2-10% | 3-8% |
| CeO₂ | 5-15% | 7-14% |
| B₂O₃ | 1-5% | 1-4% |
| BaO | 1-5% | 1-4% |

The luster frit, once fired, exhibits a high resistance to chemical and physical attack. It also exhibits a high softening point. This allows the luster frit to not be attacked by conventional glazes, and the luster effect remains, essentially floating on the surface of the glazed tile. Decorative effects such as 3-D effects can thus be obtained. Furthermore, the luster frit does not modify substantially the color development of conventional ceramic pigment-containing inkjet inks.

An inkjet composition was prepared with the composition shown in Table 2 below (parts by weight):

TABLE 2

| | | |
|---|---|---|
| Solid | Luster frit (table 1) | 38.9 parts |
| Dispersant | SOLSPERSE 13940 | 7.8 parts |
| Diluent | Ruetasolv BP-4213 | 40.0 parts |
| | Butyl diglyme | 8.0 parts |

The inkjet composition was milled until a final fineness was obtained such that the 99th percentile (d99) was 2 μm. The inkjet composition was filtered throughout a 2.4 μm absolute filter. The inkjet composition exhibited the physical properties listed in Table 3 below:

TABLE 3

| Property | T (° C.) | Value |
|---|---|---|
| Viscosity (mPa · s) | 25.0 | 30.0 |
| Density (g/mL) | 25.0 | 1.300 |
| Surface tension (mN/m) | 25.0 | 31.0 |

The inkjet composition was deposited on a ceramic substrate at a rate of approximately 100 g/m². Once fired, the ceramic substrate exhibited a luster effect. Combinations of frits leading to the same final frit composition will produce the same effect.

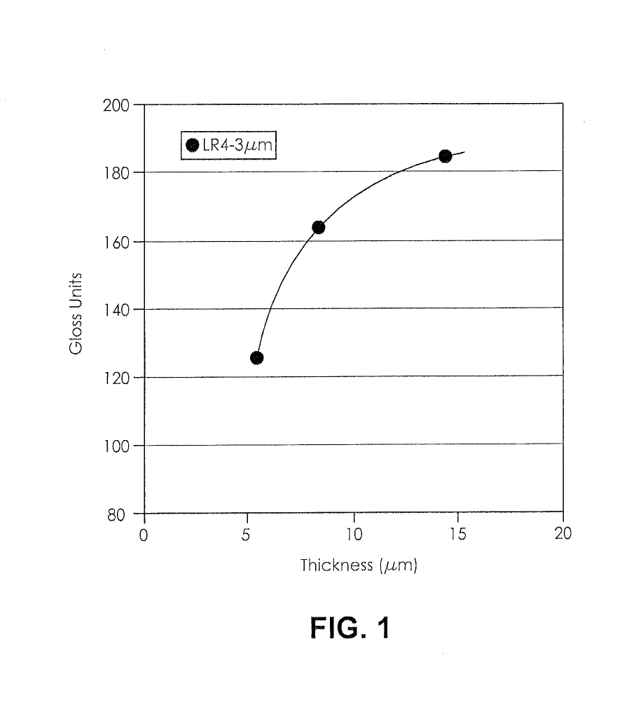

The luster effect obtained with inks containing Ce—Zr frits is superior to the luster effect previously obtained with the formerly described inks containing tungsten. The performance of the luster effect is related to the brightness of the glaze. Below in Table 4 and also found in FIG. 1 are measurements of brightness at different thickness of the coating by luster frit ink.

TABLE 4
LR-4 frit milled to 3 μm

| Particle size range (μm) | Coating thickness (μm) | 60° gloss |
|---|---|---|
| 3-8 | 5-6 | 126 |
| 7-12 | 8-9 | 164 |
| 7-20 | 14-15 | 184 |

Additional advantages and modifications will readily occur to those skilled in the art. Therefore, the invention in its broader aspects is not limited to the specific details and illustrative examples shown and described herein. Accordingly, various modifications may be made without departing from the spirit or scope of the general inventive concept as defined by the appended claims and their equivalents.

What is claimed is:

1: An inkjet composition for forming a luster effect on a surface of a ceramic or glass substrate on which said inkjet composition is applied and fired, said inkjet composition comprising one or more solvents, one or more additives for dispersion, and one or more inorganic substances, wherein said one or more inorganic substances are non-color producing solids having a particle size not greater than about 2.4 μm, the non-color producing solids comprising a glass frit comprising by weight,
from about 45 to about 65% SiO₂,
from about 8 to about 20% Al₂O₃,
from about 5 to about 15% CaO,
from about 0.1 to about 3% MgO,
from about 0.1 to about 3% Na₂O,
from about 0.1 to about 3% K₂O,
from about 5 to about 15% ZnO,
from about 2 to about 10% ZrO₂,
from about 5 to about 15% CeO₂,
from about 1 to about 5% B₂O₃, and
from about 1 to about 5% BaO.

2: The inkjet composition according to claim 1 wherein said inkjet composition has a viscosity within the range of from about 5 to about 50 mPa·s, a surface tension of from about 20 to about 40 mN/m, and a density of from about 0.8 to about 1.5 g/mL.

3: The inkjet composition according to claim 1 wherein the appearance effect is a luster effect.

4: The inkjet composition according to claim 3 wherein the glass frit comprises by weight,
from about 50 to about 60% SiO₂,
from about 9 to about 18% Al₂O₃,
from about 7 to about 14% CaO,
from about 0.1 to about 2% MgO,
from about 0.1 to about 2% Na₂O,
from about 0.1 to about 2% K₂O,
from about 5 to about 14% ZnO,
from about 3 to about 8% ZrO₂,
from about 7 to about 14% CeO₂,
from about 1 to about 4% B₂O₃, and
from about 1 to about 4% BaO.

5: A method for forming an appearance effect on a surface of a ceramic or glass substrate, the method comprising:
applying, via inkjet printing, an inkjet composition according to claim 1 to a glaze coating applied to the surface of the ceramic or glass substrate; and
firing the inkjet composition and the glaze coating to produce the appearance effect.

6: The method according to claim 5, wherein the appearance effect is a luster effect.

7: A method for forming an appearance effect on a surface of a ceramic or glass substrate, the method comprising:
applying, via inkjet printing, an inkjet composition according to claim 4 to a glaze coating applied to the surface of the ceramic or glass substrate; and
firing the inkjet composition and the glaze coating to produce the appearance effect.

8: The method according to claim 7, wherein the appearance effect is a luster effect.

9: The inkjet composition of claim 1, wherein the inkjet composition contains no tungsten.

10: The inkjet composition of claim 2, wherein the inkjet composition contains no tungsten.

11: The inkjet composition of claim 3, wherein the inkjet composition contains no tungsten.

12: The inkjet composition of claim 4, wherein the inkjet composition contains no tungsten.

13: The method according to claim 5, wherein the inkjet composition contains no tungsten.

14: The method according to claim 6, wherein the inkjet composition contains no tungsten.

15: The method according to claim 7, wherein the inkjet composition contains no tungsten.

16: The method according to claim 8, wherein the inkjet composition contains no tungsten.
